(19) United States
(12) Patent Application Publication
(10) Pub. No.: US 2026/0050345 A1
(43) Pub. Date: Feb. 19, 2026

(54) TOUCH DISPLAY DEVICE AND DRIVING METHOD THEREOF

(71) Applicant: Guangzhou China Star Optoelectronics Semiconductor Display Technology Co., LTd., Guangzhou (CN)

(72) Inventor: Qianrui XU, Guangzhou (CN)

(73) Assignee: Guangzhou China Star Optoelectronics Semiconductor Display Technology Co., LTd., Guangzhou (CN)

(21) Appl. No.: 18/933,871

(22) Filed: Oct. 31, 2024

(30) Foreign Application Priority Data
Aug. 13, 2024 (CN) 202411111266.3

(51) Int. Cl. G06F 3/041

(52) U.S. Cl. CPC G06F 3/04184; G06F 3/0412

(57) ABSTRACT

The present application provides a touch display device and a driving method thereof, the method includes: in each of the display periods of the frame cycle, the gate electrode driver circuits sequentially output scan signals to rows of the pixel units; in the touch period of each of the frame cycles, the gate electrode driver circuit of a default level in the gate electrode driver circuits outputs a square wave signal to at least one row of the pixel units; wherein the levels of the gate electrode driver circuits corresponding to the touch periods of different ones of the frame cycles are different. The touch display device and the driving method thereof provided by the present application can prolong the use lifespan of the gate electrode driver circuits.

### CROSS REFERENCE TO RELATED APPLICATIONS

This application claims the priority to Chinese Patent Application No. 202411111266.3, filed on Aug. 13, 2024. The entire disclosures of the above application are incorporated herein by reference.

### FIELD OF INVENTION

The present application relates to a field of display technologies, especially to a touch display device and a driving method thereof.

### BACKGROUND OF INVENTION

In a conventional in-cell touch display panel, gate electrode driver circuits (Gate-driver On Array, GOA) are typically used to drive the pixel units. During display periods, the gate electrode driver circuits sequentially output scan signals to each row of pixels, enabling the pixel units to correctly display images. To implement the touch functionality, touch periods (also referred to as slots) are inserted between the display periods.

In practice, the inventors have discovered that some gate electrode driver circuits in conventional in-cell touch display panels age faster and more severely than others, ultimately leading to touch functionality failures and related issues.

Therefore, it is necessary to set forth a new technical solution to prolong a use lifespan of gate electrode driver circuits.

### SUMMARY OF INVENTION

An embodiment of the present application provides a touch display device and a driving method thereof intended to prolong a use lifespan of gate electrode driver circuits thereof.

The embodiment of the present application provides a touch display device driving method, the touch display device comprises a plurality of gate electrode driver circuits connected in cascades and a plurality of pixel units arranged in rows and columns, wherein each of a plurality of frame cycles of the touch display device comprises a plurality of display periods and a plurality of touch periods, the display periods and the touch periods arranged alternately in time, and the method comprises: in each of the display periods of the frame cycle, the gate electrode driver circuits sequentially outputting scan signals to rows of the pixel units; in the touch period of each of the frame cycles, the gate electrode driver circuit of a default level in the gate electrode driver circuit transmitting a square wave signal to at least one row of the pixel units; wherein the levels of the gate electrode driver circuits corresponding to the touch periods of different ones of the frame cycles are different.

In the above driving method, the touch display device comprises the gate electrode driver circuits of n levels, and each of the frame cycles comprises m ones of the touch periods, wherein n and m are positive integers. In a first one of the frame cycles, a level of the gate electrode driver circuits corresponding to a (k)^{th} one of the touch periods is k×(n/m), wherein k is a positive integer ranging from 1 to m.

In the above driving method, in a second one of the frame cycles, a level of the gate electrode driver circuits corresponding to the (k)^{th} one of the touch periods is k×(n/m)−x, wherein x is a positive integer.

In the above driving method, x is 1.

In the above driving method, in a (n/m)^{th} one of the frame cycles, a level of the gate electrode driver circuits corresponding to a first one of the touch periods is n/m−x, and a level of the gate electrode driver circuits corresponding to a (m)^{th} one of the touch periods is n−(n/m−x).

In the above driving method, a level of the gate electrode driver circuits corresponding to the touch periods in the (n/m+1)^{th} one of the frame cycles is the same as a level of the gate electrode driver circuits corresponding to the touch periods in the first one of the frame cycles.

In the above driving method, in continuous ones of the frame cycles, the level of each of the touch periods corresponding to the gate electrode driver circuits changes cyclically.

In the above driving method, the gate electrode driver circuit of the default level is a last one of the gate electrode driver circuits outputting a scan signal in the display period.

The embodiment of the present application also provides a touch display device, each of a plurality of frame cycles of the touch display device comprises a plurality of display periods and a plurality of touch periods, the display periods and the touch periods arranged alternately in time, and the touch display device comprises: a plurality of pixel units arranged in rows and columns; and a plurality of gate electrode driver circuits connected in cascades; wherein in display periods of each of the frame cycles, the gate electrode driver circuits are configured to sequentially output scan signals to rows of the pixel units, in the touch period of each of the frame cycles, the gate electrode driver circuit of a default level in the gate electrode driver circuits outputting scan signals in the display periods is configured to output to a square wave signal at least one row of the pixel units; the levels of the gate electrode driver circuits corresponding to the touch periods of different ones of the frame cycles are different.

In the above touch display device, the touch display device comprises the gate electrode driver circuits of n levels, and each of the frame cycles comprises m ones of the touch periods, wherein n and m are positive integers. In the first one of the frame cycles, a level of the gate electrode driver circuits corresponding to the (k)^{th} one of the touch periods is k×(n/m), wherein k is a positive integer ranging from 1 to m.

In the above touch display device, in a second one of the frame cycles, a level of the gate electrode driver circuits corresponding to the (k)^{th} one of the touch periods is k×(n/m)−x, wherein x is a positive integer.

In the above touch display device, x is 1.

In the above touch display device, in a (n/m)^{th} one of the frame cycles, a level of the gate electrode driver circuits corresponding to a first one of the touch periods is n/m−x, and a level of the gate electrode driver circuits corresponding to a (m)^{th} one of the touch periods is n−(n/m−x).

In the above touch display device, a level of the gate electrode driver circuits corresponding to the touch periods in the (n/m+1)^{th} one of the frame cycles is the same as a level of the gate electrode driver circuits corresponding to the touch periods in the first one of the frame cycles.

In the above touch display device, in continuous ones of the frame cycles, the level of each of the touch periods corresponding to the gate electrode driver circuits changes cyclically.

In the above touch display device, the gate electrode driver circuit of the default level is a last one of the gate electrode driver circuits outputting a scan signal in the display period.

In the touch display device driving method provided by the embodiment of the present application, by using different levels of the gate electrode driver circuits to output square wave signals during the touch periods in different frame cycles, load balancing of the gate electrode driver circuits is achieved. This circulation method of using the gate electrode driver circuits significantly reduces the cumulative time a single gate electrode driver circuit remains in a high-level state during the touch periods, effectively lowering the stress on the gate electrode driver circuits and extending their lifespan. By prolonging the lifespan of the gate electrode driver circuits, the issue of touch function failure caused by premature aging of specific gate electrode driver circuits is avoided, thereby improving the overall reliability of the touch display device.

### DESCRIPTION OF DRAWINGS

FIG. 1 is a schematic view of a touch display device provided by an embodiment of the present application.

FIG. 2 is a timing sequence chart of a first one of frame cycles of the touch display device provided by the embodiment of the present application.

FIG. 3 is a timing sequence chart of a second one of the frame cycles of the touch display device provided by the embodiment of the present application.

FIG. 4 is a flowchart of a driving method for the touch display device provided by the embodiment of the present application.

### DETAILED DESCRIPTION OF PREFERRED EMBODIMENTS

The terms “first”, “second” and similar expressions do not indicate any order, quantity, or significance, but are merely used to distinguish between different technical features. The term “a plurality of” and similar expressions mean two or more, unless explicitly defined otherwise.

In traditional in-cell touch display panels, the start and end times of the touch periods in the frame cycles are usually fixed. Namely, during each touch detection, a fixed level of gate electrode driver circuits outputs a square wave signal. Over long-term operation, the gate electrode driver circuits at the fixed level during the touch periods endure more load compared to other levels, leading to premature aging, increased leakage current, and ultimately causing failure of the touch function.

Specifically, in traditional in-cell touch display panels, whenever the touch periods begin, it is always the fixed level gate electrode driver circuits that output the square wave signal (modulation). This means that these fixed level gate electrode driver circuits need to maintain their Q node in a high-level state during each touch cycle. Over time, this results in a significantly shorter lifespan for these gate electrode driver circuits compared to others, impacting the overall lifespan and reliability of the display panel.

Therefore, how to prolong the lifespan of the gate electrode driver circuits while ensuring the normal operation of the in-cell touch display panel, thereby improving the overall reliability and product lifespan, has become an urgent technical issue to address.

As mentioned above, when the square wave signal is output by the fixed gate electrode driver circuits during the touch periods, it leads to premature aging of the gate electrode driver circuits, thereby shortening the product's lifecycle. To solve the above technical issue, the embodiment of the present application proposes a touch display device and its driving method, aiming to prolong the lifespan of the gate electrode driver circuits and increase the product lifecycle.

Each of frame cycles of the touch display device comprises a plurality of display periods, a plurality of touch periods and a blanking period. The display periods and the touch periods are arranged alternately in time. The touch period corresponds to a touch detection time period. A changing process from the display period to the touch period is called “entering the touch period”, and a changing process of the touch period to the display period is called “exiting the touch period”. Namely, the touch period is located between two of the display periods. After one display period ends, one touch period starts, and after one touch period ends, one display period starts.

Acquisition of touch signals depends on aid square wave signals of output by the gate electrode driver circuits. In the display period, the gate electrode driver circuits output scan signals to multiple rows of the pixel units row by row until the display period ends. At this time, the touch period starts. At this time, the last one of the gate electrode driver circuits outputting the scan signal in the display period no longer outputs the scan signal, but outputs a square wave signal to the row of the pixel units. The square wave signal is configured to balance (minimize) a coupling effect of the scan line to the touch electrode. In the touch period, a touch integrated circuit □ outputs a touch detection signal to the touch electrode and receives a touch sensing signal from the touch electrode until the touch period ends. At this time, the display period starts, a next batch of the gate electrode driver circuits continue to sequentially output scan signals to multiple rows of the pixel units row by row.

The touch display device integrated with touch functions comprises a plurality of touch electrodes. To prevent touch electrodes from suffering the parasitic capacitor coupling effect of the scan lines during sensing touch actions, in the touch periods, the last one of the gate electrode driver circuits outputting the scan signal in the display period before the touch period, outputs a square wave signal (generally, low level voltage VGL±1.5V) to prevent coupling. A cycle of these square wave signals is less than a cycle of the scan signal (the frequency is greater than a frequency of the scan signal), and a voltage amplitude value of these square wave signals is also less than an amplitude value of the scan signal.

In the embodiment of the present application, the touch display device integrated with touch functions comprises a plurality of gate electrode driver circuits connected in cascades. A (N)^{th} level of gate electrode driver circuits comprises a first transistor, a second transistor, a third transistor, a fourth transistor, a fifth transistor, a sixth transistor, a seventh transistor, an eighth transistor, a ninth transistor, a tenth transistor, and a capacitor.

A gate electrode of the first transistor is electrically connected to a source electrode. The gate electrode of the first transistor is also electrically connected to a scan signal (cascade signal) output terminal G(N−1) of the gate electrode driver circuits of a (N−1)^{th} level. A drain electrode of the first transistor is electrically connected to the Q node. A gate electrode of the second transistor is electrically connected to the Q node. A source electrode of the second transistor is electrically connected to a clock signal input terminal (CK1, CK2, CK3, CK4). A drain electrode of the second transistor is electrically connected to a scan signal output terminal G(N).

Under a condition of a signal output by the scan signal (cascade signal) output terminal G(N−1) of the gate electrode driver circuits of the (N−1)^{th} level received by the gate electrode of the first transistor being at a high level, the first transistor switches on, an electric potential of the Q node is raised, the second transistor switches on, and the second transistor receives a clock signal and outputs a scan signal.

One of a source electrode and a drain electrode of the third transistor is electrically to the Q node. The other of the source electrode and the drain electrode of the third transistor is electrically connected to the low level voltage input terminal. A gate electrode of the third transistor is electrically to a scan signal (cascade signal) output terminal G(N+1) of the gate electrode driver circuit of a (N+1)^{th} level.

When in the display period, then at a next moment, a signal of the scan signal (cascade signal) output terminal G(N+1) of the gate electrode driver circuit of the (N+1)^{th} level is raised, the third transistor switches on, the electric potential of the Q node is pulled down to an electric potential of a low level voltage to complete cascade transmission of the gate electrode driver circuits.

When in the touch period, the gate electrode driver circuit of the (N+1)^{th} level is still waiting to output a scan signal, a signal of a scan signal (cascade signal) output terminal G(N+1) of the gate electrode driver circuit of the (N+1)^{th} level is not a high level signal, but is the low level signal as maintained before, the third transistor receiving the signal of the scan signal (cascade signal) output terminal G(N+1) of the gate electrode driver circuit of the (N+1)^{th} level would not switch on. Therefore, the Q node in the touch periods keeps the high level state. A duration time is about 200 microseconds to 500 microseconds. At this time, a signal output by the scan signal output terminal of the gate electrode driver circuit of the (N)^{th} level is a square wave signal (clock signal). Namely, the square wave signal is the clock signal until “out of the touch period” (the touch period ends), then the Q node electric potential is pulled down.

One of a source electrode and a drain electrode of the fourth transistor is electrically connected to a low level voltage input terminal, and the other of the source electrode and the drain electrode of the fourth transistor is electrically connected to the scan signal output terminal G(N). One of a source electrode and a drain electrode of the fifth transistor is electrically connected to the low level voltage input terminal, and the other of the source electrode and the drain electrode of the fifth transistor is electrically connected to the Q node. A gate electrode of the sixth transistor is electrically connected to a high level signal input terminal, and the gate electrode of the sixth transistor is electrically connected to the sixth transistor one of a source electrode and a drain electrode. A gate electrode of the seventh transistor is electrically connected to the Q node, one of a source electrode and a drain electrode of the seventh transistor is electrically connected to the low level voltage input terminal, and the other of the source electrode and the drain electrode of the seventh transistor is electrically connected to the other of the source electrode and the drain electrode of the sixth transistor. A gate electrode of the eighth transistor is electrically connected to the other of the source electrode and the drain electrode of the sixth transistor. One of a source electrode and a drain electrode of the seventh transistor is electrically connected to a high level voltage input terminal, and the other of the source electrode and the drain electrode of the seventh transistor is electrically connected to a gate electrode of the fourth transistor and a gate electrode of the fifth transistor. A gate electrode of the ninth transistor is electrically connected to the Q node, one of a source electrode and a drain electrode of the ninth transistor is electrically connected to the low level voltage input terminal, and the other of the source electrode and the drain electrode of the ninth transistor is electrically connected to the gate electrode of the fourth transistor and the gate electrode of the fifth transistor. A gate electrode of the tenth transistor is electrically connected to a touch signal input terminal. One of a source electrode and a drain electrode of the tenth transistor is electrically connected to the low level voltage input terminal, and the other of the source electrode and the drain electrode of the tenth transistor is electrically connected to the scan signal output terminal G(N). The scan signal output terminal G(N) and the gate electrode of the second transistor constitute the capacitor.

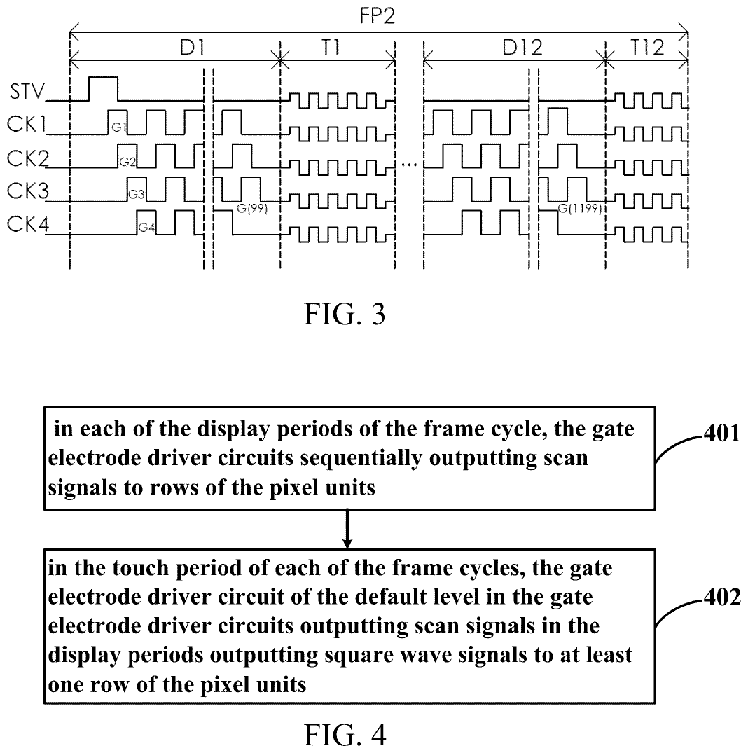

With reference to FIG. 2 and FIG. 3, the touch display device integrated with touch functions comprising the gate electrode driver circuits of 1200 levels, four clock signal lines (CK1, CK2, CK3, and CK4), one frame cycle comprising twelve touch periods and twelve display periods are used as an example, as follows:

In a first one of the frame cycles FP1, in a first one of the display periods D1, from the first one of the gate electrode driver circuits (G1), the gate electrode driver circuits (G1) start to output scan signals to pixel units row by row until a hundredth one of the gate electrode driver circuits completely outputs the scan signal. At this time, a first one of the touch periods T1 starts. Namely, a hundred of the gate electrode driver circuits output scan signals row by row. When the hundredth one of the gate electrode driver circuits (G100) completely outputs the scan signal, the first one of the touch periods T1 starts. In this touch period, the hundredth one of the gate electrode driver circuits outputs square wave signals until the touch period ends. Then, a second of the display periods starts. At least time, continuous from a 101^{th} one of the gate electrode driver circuits (G101), the gate electrode driver circuits (G101) start to output scan signals to pixel units row by row until a 200^{th} one of the gate electrode driver circuits (G200) completely outputs the scan signal, a second one of the touch periods starts. Namely, the hundred of the gate electrode driver circuits output scan signals row by row. When the 200^{th} one of the gate electrode driver circuits (G200) completely outputs the scan signal, the second one of the touch periods starts. In this touch period, the 200^{th} one of the gate electrode driver circuits outputs square wave signals until the touch period ends, and so on. When the 1200^{th} one of the gate electrode driver circuits (G1200) completely outputs the scan signal, a twelfth one of the display periods D12 ends, and a twelfth one of the touch periods T12 starts. In this touch period, the 1200^{th} one of the gate electrode driver circuits outputs square wave signals until the touch period ends.

In a second one of the frame cycles FP2, in the first one of the display periods D1, from the first one of the gate electrode driver circuits (G1), the gate electrode driver circuits (G1) start to output scan signals to pixel units row by row until a 99^{th} one of the gate electrode driver circuits (G99) completely outputs the scan signal. The first one of the touch periods T1 starts after the 99^{th} one of the gate electrode driver circuits (G99) completely outputs the scan signal. Namely, 99 ones of the gate electrode driver circuits output scan signals row by row. When the 99^{th} one of the gate electrode driver circuits (G99) completely outputs the scan signal, the first one of the touch periods T1 starts. In this touch period, the 99^{th} one of the gate electrode driver circuits outputs square wave signals until the touch period ends. Then, the second of the display period starts. At this time, the hundredth one of the gate electrode driver circuits (G100) starts to output scan signals to pixel units row by row until a 199^{th} one of the gate electrode driver circuits (G199) completely outputs the scan signal. The second one of the touch periods starts. Namely, the hundred of the gate electrode driver circuits output scan signals row by row. When the 199^{th} one of the gate electrode driver circuits (G199) completely outputs the scan signal, the second one of the touch periods starts. In this touch period, the 199^{th} one of the gate electrode driver circuits (G199) outputs square wave signals until the touch period ends, and so on. When a 1199^{th} one of the gate electrode driver circuits (G1199) completely outputs the scan signal, the twelfth one of the display periods D12 ends, and the twelfth one of the touch periods T12 starts. In this touch period, the 1199^{th} one of the gate electrode driver circuits outputs square wave signals until the touch period ends. Namely, in the second one of the frame cycles FP2, relative to the first one of the frame cycles FP1, start times of all of the touch periods move forward by a time (waiting time) when the gate electrode driver circuit of a level (x levels) outputs scan signals.

Similarly, in the hundredth one of the frame cycles, when the first one of the gate electrode driver circuits (G1) completely outputs the scan signal, the first one of the touch periods starts. When a 1101^{th} one of the gate electrode driver circuits (G1101) completely outputs the scan signal, the twelfth one of the touch periods starts. In the 101^{th} one of the frame cycles, a circulation of the first frame is repeated. When the hundredth one of the gate electrode driver circuits (G100) completely outputs the scan signal, the first one of the touch periods starts, . . . , when the 1200^{th} one of the gate electrode driver circuits (G1200) completely outputs the scan signal, the twelfth one of the touch periods starts.

The touch display device integrated with touch functions comprising the gate electrode driver circuits of n levels and each frame cycle comprising m ones of the touch periods is used as an example, as follows:

In the first one of the frame cycles FP1, starting from G1, after G(n/m*1) completely outputs the scan signal, the first one of the touch periods starts, after G(n/m*2) completely outputs the scan signal, the second one of the touch periods starts, . . . , and after G(n/m*m) completely outputs the scan signal, the (m)^{th} one of the touch periods starts.

In the second one of the frame cycles FP2, starting from G1, after G(n/m*1−1) completely outputs the scan signal, the first one of the touch periods starts, after G(n/m*2−1) completely outputs the scan signal, the second one of the touch periods starts, . . . , and after G(n/m*m−1) completely outputs the scan signal, the (m)^{th} one of the touch periods starts. Namely, relative to the first frame, start times of all of the touch periods move forward by a time when the gate electrode driver circuit of a level outputs the scan signals earlier.

Similarly, in a (n/m)^{th} one of the frame cycles, after G1 completely outputs the scan signal, the first one of the touch periods starts, after G(n/m*m-(n/m−1)) completely outputs the scan signal, the (m)^{th} one of the touch periods starts, after a (n/m+1)^{th} frame, the first one of the frame cycles FP1 is repeated, then it is cyclically repeated.

By the method of the above circulation touch periods, different ones of the gate electrode driver circuits can output square wave signals in the touch periods of adjacent frames. In comparison with a conventional technical solution of the fixed gate electrode driver circuits outputting square wave signals in the touch periods, the technical solution of the circulation touch periods of the embodiment of the present application drastically reduces the time of the Q node of a single gate electrode driving power maintaining a high level in a unit time.

The example above illustrates that, in the traditional technical solution where the gate electrode driver circuits output a square wave signal during the touch periods, within 100 frames, the Q node of the gate electrode driver circuits, which consistently outputs a square wave signal, remains at a high level for at least 100*200 microseconds=20,000 microseconds. However, in the technical solution involving circulation touch periods provided by the embodiment of the present application, within 100 frames, each of the gate electrode driver circuits outputs a square wave signal. That is, each of the gate electrode driver circuits needs to maintain the Q node at a high level for a certain period of time. In this solution, during a 100-frame cycle, the Q node of each gate electrode driver circuit remains at a high level for 200 microseconds, significantly reducing the stress on the gate electrode driver circuits and extending their lifespan.

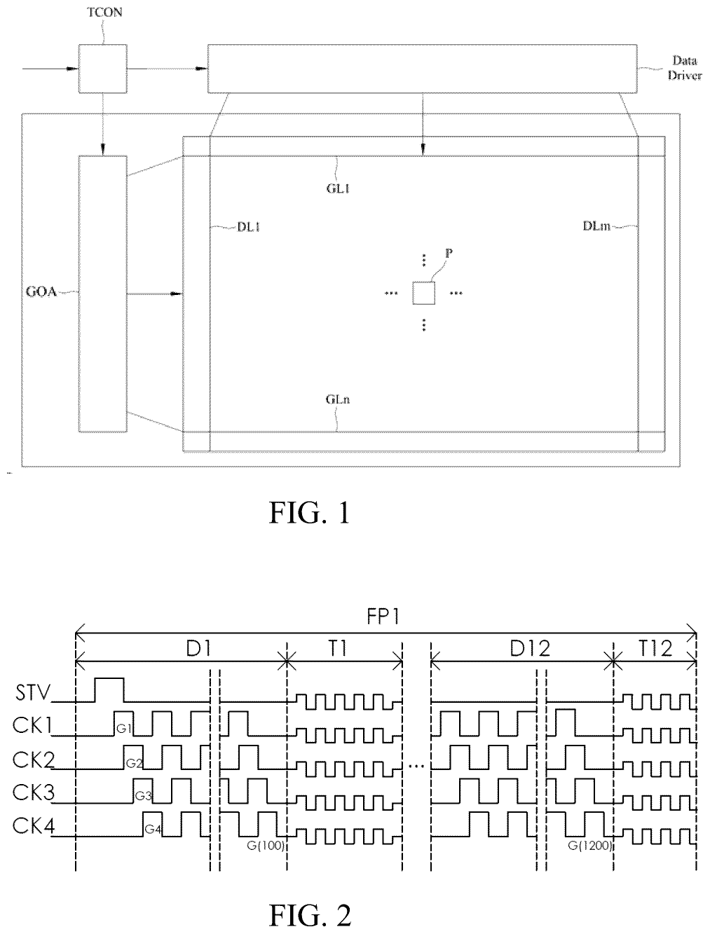

The touch display device provided by the embodiment of the present application, for example, can be a LCD touch display device, or an OLED touch display device, as shown in FIG. 1. The touch display device comprises a display panel, a timing controller TCON, a source electrode driver chip DataDriver, touch chip (not shown in the figures), and a power management chip (not shown in the figures). The power management chip and the timing controller TCON can be integrated into a chip). The display panel comprises a plurality of the pixels P, a plurality of scan lines (GL1˜GLn), a plurality of data lines (DL1˜DLm), and a gate electrode driver GOA. The pixels P are arranged in rows and columns. The gate electrode driver GOA is electrically connected to the scan lines (GL1˜GLn). The gate electrode driver GOA comprises a plurality of the gate electrode driver circuits. Each of the gate electrode driver circuits is electrically connected to one of the scan lines (GL1˜GLn). The source electrode driver chip DataDriver is electrically connected to the data lines (DL1˜DLm). The scan lines (GL1˜GLn) and the data lines (DL1˜DLm) are electrically connected to the pixels P. The timing controller TCON and the gate electrode driver GOA are electrically connected to the source electrode driver chip DataDriver. The touch chip is electrically connected to the touch electrode integrated in the display panel.

Under a condition of the display panel being a LCD display panel and the display panel comprises a thin film transistor array substrate, an opposite substrate and liquid crystal material disposed between the thin film transistor array substrate and the opposite substrate. The thin film transistor array substrate comprises a substrate, a gate electrode driver GOA, pixels P, scan lines (GL1˜GLn), data lines (DL1˜DLm), and a color resist. The pixels P comprises a thin film transistor and a pixel electrode. The thin film transistor is electrically connected to the pixel electrode, the scan lines (GL1˜GLn), and the data lines (DL1˜DLm).

Under a condition of the display panel being an organic light emitting diode (OLED) display panel, the display panel comprises a substrate, the pixels P, a gate electrode driver GOA, an organic light emitting device, an encapsulation layer, a polarizer, and a color filter. The substrate, for example, can be a glass substrate or a flexible substrate (for example, polyimide substrate). The pixel P comprises an organic light emitting device (OLED) and a driver circuit. The driver circuit comprises a plurality of thin film transistors. The organic light emitting device is electrically connected to the driver circuit. The organic light emitting device comprises a light emitting layer, an electron transport layer, a hole transport layer, a cathode, and an anode. The encapsulation layer comprises a multi-layer structure of alternate organic and inorganic layers.

The gate electrode driver GOA comprises the gate electrode driver circuits of levels connected in cascades. The gate electrode driver circuits of each level is electrically connected to a row of the pixels P. The gate electrode driver circuit is configured to provide a row of the pixels P with scan signals.

The source electrode driver chip DataDriver is configured to provide a column the pixels P with data signals.

The timing controller TCON is configured to received externally input image data, control the gate electrode driver GOA to output scan signals, and control the source electrode driver chip DataDriver to output data signals.

the power management chip is configured to supply each part of the display device with a necessary work voltage.

The embodiment of the present application provides a touch display device, each of frame cycles of the touch display device comprises a plurality of the display periods and a plurality of the touch periods, the display periods and the touch periods are arranged alternately in time, and the touch display device comprises:
a plurality of pixel units arranged in rows and columns; and
a plurality of the gate electrode driver circuits connected in cascades;
wherein in display periods of each of the frame cycles, the gate electrode driver circuits is configured to sequentially output scan signals to rows of the pixel units, in the touch period of each of the frame cycles, the gate electrode driver circuit of a default level in the gate electrode driver circuits outputting scan signals in the display periods is configured to output square wave signals to at least one row of the pixel units;
the levels of the gate electrode driver circuits corresponding to the touch periods of different ones of the frame cycles are different.

Namely, in the first frame cycle, a first set of the gate electrode driver circuits is configured to output square wave signals to the pixel units in a plurality of the touch periods. In the second frame cycle, a second set of the gate electrode driver circuits is configured to output square wave signals to the pixel units in a plurality of the touch periods. The level of the second set of the gate electrode driver circuits is different from the level of the first set of the gate electrode driver circuits.

Namely, in continuous ones of the frame cycles, the level of the gate electrode driver circuits outputting square wave signals to the pixel units in each of the touch periods cyclically changes.

In each of the display periods, the gate electrode driver circuits are configured to sequentially output scan signals to multiple rows of pixels. In each of the touch periods, the gate electrode driver circuit of the default level in the gate electrode driver circuits outputting scan signals in the display periods is configured to output square wave signals to at least one row of the pixel units.

A cycle of the square wave signal is less than a cycle of the scan signal. A voltage amplitude value of the square wave signal is less than a voltage amplitude value of the scan signal. A frequency of the square wave signal is greater than a frequency of the scan signal.

In each of the touch periods, a node Q of the gate electrode driver circuit of the default level outputting the square wave signal keep a high level state, a duration time thereof ranges from 200us to 500us.

The square wave signal is configured to balance (eliminate) the coupling effect of the scan line to the touch electrode.

An amplitude value of the square wave signal is a low level VGL of a gate electrode driving signal±1.5V.

The touch display device comprises the gate electrode driver circuits of n levels, and each of the frame cycles comprises m ones of the touch periods (slot). n and m are positive integers.

In a first one of the frame cycles, a level of the gate electrode driver circuits corresponding to a (k)^{th} one of the touch periods is k×(n/m), wherein k is a positive integer ranging from 1 to m.

In a second one of the frame cycles, a level of the gate electrode driver circuits corresponding to the (k)^{th} one of the touch periods is k×(n/m)−x, wherein x is a positive integer. Preferably, x is 1. Namely, in the second one of the frame cycles FP2, the level of the gate electrode driver circuits corresponding to each of the touch periods is decreased by x relative to the first frame, namely, becomes k×(n/m)−x. This offset x can also be adjusted according to actual demands.

In a (n/m)^{th} one of the frame cycles, a level of the gate electrode driver circuits corresponding to a first one of the touch periods is n/m−x, a level of the gate electrode driver circuits corresponding to the (m)^{th} one (the last one) of the touch periods is n−(n/m−x).

Starting from the second frame, the level of the gate electrode driver circuits in each frame is reduced by x levels on the basis of a previous frame, and usually x is 1. Such decreasing mode is sustained by n/m frames, thereby forming a full cycle.

Namely, in the end of each of the frame cycles, the level of each of the touch periods corresponding to the gate electrode driver circuits in a next one of the frame cycles is decreased by x.

After this cycle completes, a (n/m+1)^{th} one of the frame cycles repeats the distribution of the first frame and cyclically acts.

A level of the gate electrode driver circuits corresponding to the touch period in a (n/m+1)^{th} one of the frame cycles is the same as a level of the gate electrode driver circuits corresponding to the touch periods in the first one of the frame cycles.

In each of the frame cycles, the levels of the gate electrode driver circuits corresponding to adjacent two of the touch periods is n/m.

In continuous ones of the frame cycles, the level of each of the touch periods corresponding to the gate electrode driver circuits changes cyclically.

The gate electrode driver circuit of the default level is a last one of the gate electrode driver circuits outputting a scan signal in the display period. Namely, in the touch period, the gate electrode driver circuit outputting square wave signals is the last one of the gate electrode driver circuits outputting the scan signals in the display period. As such, a switching time from the display mode to the touch mode can be maximally reduced Because the last one of the gate electrode driver circuits has been already in the work state, it only requires to change the type of the signal output thereby, and thereby facilitating reduction of signal interference because adjacent ones of the gate electrode driver circuits would not be in the signal output state simultaneously.

In the touch display device provided by the embodiment of the present application, a location of the square wave signal (clock signal CK) along a time axis cyclically moves relative a location of a start signal STV received by the gate electrode driver circuit along the time axis. Such cyclical movement property reflects that levels of different gate electrode driver circuits change cyclically in the touch periods in different frame cycles. In particular, in each of the frame cycles, the square wave signal (clock signal CK) would relative to the start signal STV would shift backward by a time of levels of x ones of the gate electrode driver circuits until a full circulation completes, and each n/m frame completes a full circulation.

In the touch display device provided by the embodiment of the present application, by using different levels of the gate electrode driver circuits to output square wave signals during the touch periods in different frame cycles, load balancing of the gate electrode driver circuits is achieved. This circulation method of using the gate electrode driver circuits significantly reduces the cumulative time a single gate electrode driver circuit remains in a high-level state during the touch periods, effectively lowering the stress on the gate electrode driver circuits and extending their lifespan. By prolonging the lifespan of the gate electrode driver circuits, the issue of touch function failure caused by premature aging of specific gate electrode driver circuits is avoided, thereby improving the overall reliability of the touch display device.

The touch display device further comprises a control circuit. The control circuit is configured to record, in the frame cycles, a number of times each of the gate electrode driver circuits outputs square wave signals in the touch periods, and adjust a variation rule of the levels of the gate electrode driver circuits corresponding to the touch periods according to the number.

To further optimize use of the gate electrode driver circuits, the control circuit monitors cumulative times of each of the gate electrode driver circuits in the touch periods outputting square wave signals in real time. When it is monitored that use frequencies of some of the gate electrode driver circuits are higher or lower than an average, the control circuit dynamically adjusts a level assignment rule to ensure that the use frequency of each of the gate electrode driver circuits is uniform in long term operation by temporarily changing the x value or adjusting an initial assignment rule, thereby effectively preventing the gate electrode driver circuits from prematurely aging and further prolonging the use lifespan of the overall touch display device.

The control circuit can be integrated in a timing controller of the touch display device. The timing controller is configured to normally drive the display, and dynamically assign the touch detection time sequence and the gate electrode driver circuits level.

As an improvement, the control circuit is further configured to, while detecting malfunction of a certain one of the gate electrode driver circuits, adjust the assignment rule, skip the malfunctioning gate electrode driver circuit, prevent using the malfunctioning gate electrode driver circuit to output a square wave signal, and evenly assign loads to the gate electrode driver circuits other than the malfunctioning gate electrode driver circuit.

As an improvement, the control circuit is further configured to extend or shorten a time length of the touch period. Namely, a time length of the gate electrode driver circuit of the default level outputting square wave signals to at least one row of the pixel units is controlled. For example, when frequent touch operations are detected, the control circuit increases a duration time of the touch period to improve a touch responsive speed. On the contrary, when no touch operation is detected in a long time, the control circuit shortens the touch periods.

As an improvement, the control circuit is further configured to dynamically adjust a number (m value) of the touch periods in each of the frame cycles according to a refresh rate of a display image of touch display device, and adjust a level assignment rule of the gate electrode driver circuits. For example, the higher the refresh rate and the touch detection rate are, the greater the m value is, vice versa.

As an improvement, the control circuit is further configured to calculate and assign the gate electrode driver circuits of n levels corresponding to each of the touch periods, and record the levels in a mapping table. The mapping table comprises a correspondence relationship between each of the touch periods and the levels of the gate electrode driver circuits in each of the frame cycles. The control circuit is further configured to, before each of the display periods ends, find a level of the gate electrode driver circuit in a next one of the touch periods which should output a square wave signal from the mapping table according to serial numbers of a current frame cycle and the touch periods, and then transmit a control signal to the gate electrode driver circuit of the corresponding level to make the gate electrode driver circuit output a square wave signal in a subsequent touch period.

As an improvement, the control circuit is further configured to, according to total levels of the gate electrode driver circuits and a touch period number m of each frame, calculate n/m. n/m is a basic offset, and is also a circulation cycle.

As an improvement, the control circuit is further configured to, in the frame cycles, monitor a work state of each of the gate electrode driver circuits, and adjust a variation rule of the levels of the gate electrode driver circuits corresponding to the touch periods according to the work state.

In the touch display device provided by the embodiment of the present application, real time monitoring and self-adaptive adjusting the levels of the gate electrode driver circuits outputting square wave signals to at least one row of the pixels prolongs the use lifespan of the gate electrode driver circuits and improves overall performance and reliability of the touch display device.

A touch display device driving method provided by the embodiment of the present application comprises:
a step 401 comprising in each of the display periods of the frame cycle, the gate electrode driver circuits sequentially outputting scan signals to rows of the pixel units;
a step 402 comprising in the touch period of each of the frame cycles, the gate electrode driver circuit of the default level in the gate electrode driver circuits outputting scan signals in the display periods outputting square wave signals to at least one row of the pixel units;
wherein the levels of the gate electrode driver circuits corresponding to the touch periods of different ones of the frame cycles are different.

Namely, the method comprises:
in continuous ones of the frame cycles, cyclically changing the levels of the gate electrode driver circuits outputting square wave signals to the pixel units in each of the touch periods.

In each of the display periods, the gate electrode driver circuits sequentially output scan signals to multiple rows of pixels. In each of the touch periods, the gate electrode driver circuit of the default level in the gate electrode driver circuits outputting scan signals in the display periods outputs square wave signals to at least one row of the pixel units.

A cycle of the square wave signal is less than a cycle of the scan signal. A voltage amplitude value of the square wave signal is less than a voltage amplitude value of the scan signal. A frequency of the square wave signal is greater than a frequency of the scan signal.

In each of the touch periods, a node Q of the gate electrode driver circuit of the default level outputting the square wave signal keep a high level state, a duration time thereof ranges from 200 us to 500 us.

The square wave signal is configured to balance (eliminate) the coupling effect of the scan line to the touch electrode.

An amplitude value of the square wave signal is a low level VGL of a gate electrode driving signal±1.5V.

The touch display device comprises the gate electrode driver circuits of n levels, and each of the frame cycles comprises m ones of the touch periods, wherein n and m are positive integers.

In the first one of the frame cycles, a level of the gate electrode driver circuits corresponding to the (k)^{th} one of the touch periods is k×(n/m), wherein k is a positive integer ranging from 1 to m.

In a second one of the frame cycles, a level of the gate electrode driver circuits corresponding to the (k)^{th} one of the touch periods is k×(n/m)−x, wherein x is a positive integer. Preferably, x is 1. Namely, in the second one of the frame cycles FP2, the level of the gate electrode driver circuits corresponding to each of the touch periods is decreased by x relative to the first frame, namely, becomes to k×(n/m)−x. This offset x can also be adjusted according to actual demands.

In a (n/m)^{th} one of the frame cycles, a level of the gate electrode driver circuits corresponding to a first one of the touch periods is n/m−x, and a level of the gate electrode driver circuits corresponding to a (m)^{th} one of the touch periods is n−(n/m−x).

Namely, in the end of each of the frame cycles, the level of each of the touch periods corresponding to the gate electrode driver circuits in a next one of the frame cycles is decreased by x.

After this cycle completes, a (n/m+1)^{th} one of the frame cycles repeats the distribution of the first frame and cyclically acts.

a level of the gate electrode driver circuits corresponding to the touch periods in the (n/m+1)^{th} one of the frame cycles is the same as a level of the gate electrode driver circuits corresponding to the touch periods in the first one of the frame cycles.

In each of the frame cycles, the levels of the gate electrode driver circuits corresponding to adjacent two of the touch periods is n/m.

In continuous ones of the frame cycles, the level of each of the touch periods corresponding to the gate electrode driver circuits changes cyclically.

The gate electrode driver circuit of the default level is a last one of the gate electrode driver circuits outputting a scan signal in the display period. Namely, in the touch period, the gate electrode driver circuit outputting square wave signals is the last one of the gate electrode driver circuits outputting the scan signals in the display period. As such, a switching time from the display mode to the touch mode can be maximally reduced Because the last one of the gate electrode driver circuits has been already in the work state, it only requires to change the type of the signal output thereby, and thereby facilitating reduction of signal interference because adjacent ones of the gate electrode driver circuits would not be in the signal output state simultaneously.

In the touch display device provided by the embodiment of the present application driving method, a location of the square wave signal (clock signal CK) along a time axis cyclically moves relative to a location of a start signal STV received by the gate electrode driver circuit along the time axis. Such cyclical movement property reflects that levels of different gate electrode driver circuits change cyclically in the touch periods in different frame cycles. In particular, in each of the frame cycles, the square wave signal (clock signal CK) would relative to the start signal STV would shift backward by a time of levels of x ones of the gate electrode driver circuits until a full circulation completes, and each n/m frame completes a full circulation.

The method further comprises:
in the touch periods, by the touch integrated circuit, outputting a touch detection signal to the touch electrode, and receiving a touch sensing signal from the touch electrode.

In the touch display device driving method provided by the embodiment of the present application, by using different levels of the gate electrode driver circuits to output square wave signals during the touch periods in different frame cycles, load balancing of the gate electrode driver circuits is achieved. This circulation method of using the gate electrode driver circuits significantly reduces the cumulative time a single gate electrode driver circuit remains in a high-level state during the touch periods, effectively lowering the stress on the gate electrode driver circuits and extending their lifespan. By prolonging the lifespan of the gate electrode driver circuits, the issue of touch function failure caused by premature aging of specific gate electrode driver circuits is avoided, thereby improving the overall reliability of the touch display device.

The touch display device provided by the embodiment of the present application driving method further comprises:
in the frame cycles, recording a number of times each of the gate electrode driver circuits outputs square wave signals in the touch periods;
adjusting a variation rules of the levels of the gate electrode driver circuits corresponding to the touch periods according to the number.

To further optimize use of the gate electrode driver circuits, the control circuit monitors cumulative times of each of the gate electrode driver circuits in the touch periods outputting square wave signals in real time. When it is monitored that use frequencies of some of the gate electrode driver circuits are higher or lower than an average, the control circuit dynamically adjusts a level assignment rule to ensure that the use frequency of each of the gate electrode driver circuits is uniform in long term operation by temporarily changing the x value or adjusting an initial assignment rule, thereby effectively preventing the gate electrode driver circuits from prematurely aging and further prolonging the use lifespan of the overall touch display device.

As an improvement, the control circuit, while detecting malfunction of a certain one of the gate electrode driver circuits, adjusts the assignment rule, skips the malfunctioning gate electrode driver circuit, prevents using the malfunctioning gate electrode driver circuit to output a square wave signal, and evenly assigns loads to the gate electrode driver circuits other than the malfunctioning gate electrode driver circuit.

As an improvement, the control circuit extends or shortens a time length of the touch period. Namely, a time length of the gate electrode driver circuit of the default level outputting square wave signals to at least one row of the pixel units is controlled. For example, when frequent touch operations are detected, the control circuit increases a duration time of the touch period to improve a touch responsive speed. On the contrary, when no touch operation is detected in a long time, the control circuit shortens the touch periods.

As an improvement, the control circuit dynamically adjusts a number (m value) of the touch periods in each of the frame cycles according to a refresh rate of a display image of touch display device, and adjusts a level assignment rule of the gate electrode driver circuits. For example, the higher the refresh rate and the touch detection rate are, the greater the m value is, vice versa.

As an improvement, the control circuit calculates and assigns levels of the gate electrode driver circuits corresponding to each of the touch periods, and record the levels in a mapping table. The mapping table comprises a correspondence relationship between each of the touch periods and the levels of the gate electrode driver circuits in each of the frame cycles. The control circuit, before each of the display periods ends, finds a level of the gate electrode driver circuit in a next one of the touch periods which should output a square wave signal from the mapping table according to serial numbers of a current frame cycle and the touch periods, and then transmits a control signal to the gate electrode driver circuit of the corresponding level to make the gate electrode driver circuit output a square wave signal in a subsequent touch period.

As an improvement, the control circuit, according to total levels of the gate electrode driver circuits and a touch period number m of each frame, calculates n/m. n/m is a basic offset, and is also a circulation cycle.

As an improvement, the control circuit, in the frame cycles, monitors a work state of each of the gate electrode driver circuits, and adjusts a variation rule of the levels of the gate electrode driver circuits corresponding to the touch periods according to the work state.

In the touch display device provided by the embodiment of the present application driving method, real time monitoring and self-adaptive adjusting the levels of the gate electrode driver circuits outputting square wave signals to at least one row of the pixels prolongs the use lifespan of the gate electrode driver circuits and improves overall performance and reliability of the touch display device.

The embodiment of the present application are described in detail as above. The contents of the present specification should not be construed as limiting the protection range of the present application.

1. A touch display device driving method, wherein the touch display device comprises a plurality of gate electrode driver circuits connected in cascades and a plurality of pixel units arranged in rows and columns, wherein each of a plurality of frame cycles of the touch display device comprises a plurality of display periods and a plurality of touch periods, the display periods and the touch periods arranged alternately in time, and the method comprises:
in each of the display periods of the frame cycle, the gate electrode driver circuits sequentially outputting scan signals to rows of the pixel units;
in the touch period of each of the frame cycles, the gate electrode driver circuit of a default level in the gate electrode driver circuit transmitting a square wave signal to at least one row of the pixel units;
wherein the levels of the gate electrode driver circuits corresponding to the touch periods of different ones of the frame cycles are different.

2. The driving method according to claim 1, wherein the touch display device comprises the gate electrode driver circuits of n levels, and each of the frame cycles comprises m ones of the touch periods, wherein n and m are positive integers;
in a first one of the frame cycles, a level of the gate electrode driver circuits corresponding to a (k)^{th} one of the touch periods is k×(n/m), wherein k is a positive integer ranging from 1 to m.

3. The driving method according to claim 2, wherein in a second one of the frame cycles, a level of the gate electrode driver circuits corresponding to the (k)^{th} one of the touch periods is k×(n/m)−x, wherein x is a positive integer.

4. The driving method according to claim 3, wherein x is 1.

5. The driving method according to claim 3, wherein in a (n/m)^{th} one of the frame cycles, a level of the gate electrode driver circuits corresponding to a first one of the touch periods is n/m−x, and a level of the gate electrode driver circuits corresponding to a (m)^{th} one of the touch periods is n−(n/m−x).

6. The driving method according to claim 5, wherein a level of the gate electrode driver circuits corresponding to the touch period in a (n/m+1)^{th} one of the frame cycles is the same as a level of the gate electrode driver circuits corresponding to the touch periods in the first one of the frame cycles.

7. The driving method according to claim 1, wherein in continuous ones of the frame cycles, the level of each of the touch periods corresponding to the gate electrode driver circuits changes cyclically.

8. The driving method according to claim 1, wherein the gate electrode driver circuit of the default level is a last one of the gate electrode driver circuits outputting a scan signal in the display period.

9. A touch display device, wherein each of a plurality of frame cycles of the touch display device comprises a plurality of display periods and a plurality of touch periods, the display periods and the touch periods arranged alternately in time, and the touch display device comprises:
a plurality of pixel units arranged in rows and columns; and
a plurality of gate electrode driver circuits connected in cascades;
wherein in display periods of each of the frame cycles, the gate electrode driver circuits are configured to sequentially output scan signals to rows of the pixel units, in the touch period of each of the frame cycles, the gate electrode driver circuit of a default level in the gate electrode driver circuits outputting scan signals in the display periods is configured to output to a square wave signal at least one row of the pixel units;
the levels of the gate electrode driver circuits corresponding to the touch periods of different ones of the frame cycles are different.

10. The touch display device according to claim 9, wherein the touch display device comprises the gate electrode driver circuits of n levels, and each of the frame cycles comprises m ones of the touch periods, wherein n and m are positive integers;
in a first one of the frame cycles, a level of the gate electrode driver circuits corresponding to a (k)^{th} one of the touch periods is k×(n/m), wherein k is a positive integer ranging from 1 to m.

11. The touch display device according to claim 10, wherein in a second one of the frame cycles, a level of the gate electrode driver circuits corresponding to the (k)^{th} one of the touch periods is k×(n/m)−x, wherein x is a positive integer.

12. The touch display device according to claim 11, wherein x is 1.

13. The touch display device according to claim 11, wherein in a (n/m)^{th} one of the frame cycles, a level of the gate electrode driver circuits corresponding to a first one of the touch periods is n/m−x, and a level of the gate electrode driver circuits corresponding to a (m)^{th} one of the touch periods is n−(n/m−x).

14. The touch display device according to claim 13, wherein a level of the gate electrode driver circuits corresponding to the touch period in a (n/m+1)^{th} one of the frame cycles is the same as a level of the gate electrode driver circuits corresponding to the touch periods in the first one of the frame cycles.

15. The touch display device according to claim 9, wherein in continuous ones of the frame cycles, the level of each of the touch periods corresponding to the gate electrode driver circuits changes cyclically.

16. The touch display device according to claim 9, wherein the gate electrode driver circuit of the default level is a last one of the gate electrode driver circuits outputting a scan signal in the display period.

17. A touch display device, wherein each of a plurality of frame cycles of the touch display device comprises a plurality of display periods and a plurality of touch periods, the display periods and the touch periods arranged alternately in time, and the touch display device comprises:
a plurality of pixel units arranged in rows and columns; and
a plurality of gate electrode driver circuits connected in cascades;
wherein in display periods of each of the frame cycles, the gate electrode driver circuits are configured to sequentially output scan signals to rows of the pixel units, in the touch period of each of the frame cycles, the gate electrode driver circuit of a default level in the gate electrode driver circuits outputting scan signals in the display periods is configured to output to a square wave signal at least one row of the pixel units;
the levels of the gate electrode driver circuits corresponding to the touch periods of different ones of the frame cycles are different;
wherein the touch display device comprises the gate electrode driver circuits of n levels, and each of the frame cycles comprises m ones of the touch periods, wherein n and m are positive integers;
in a first one of the frame cycles, a level of the gate electrode driver circuits corresponding to a (k)^{th} one of the touch periods is k×(n/m), wherein k is a positive integer ranging from 1 to m;
wherein in a second one of the frame cycles, a level of the gate electrode driver circuits corresponding to the (k)^{th} one of the touch periods is k×(n/m)−x, wherein x is a positive integer;
wherein x is 1;
wherein in a (n/m)^{th} one of the frame cycles, a level of the gate electrode driver circuits corresponding to a first one of the touch periods is n/m−x, and a level of the gate electrode driver circuits corresponding to a (m)^{th} one of the touch periods is n−(n/m−x).

18. The touch display device according to claim 17, wherein a level of the gate electrode driver circuits corresponding to the touch period in a (n/m+1)^{th} one of the frame cycles is the same as a level of the gate electrode driver circuits corresponding to the touch periods in the first one of the frame cycles.

19. The touch display device according to claim 17, wherein in continuous ones of the frame cycles, the level of each of the touch periods corresponding to the gate electrode driver circuits changes cyclically.

20. The touch display device according to claim 17, wherein the gate electrode driver circuit of the default level is a last one of the gate electrode driver circuits outputting a scan signal in the display period.
